(19) United States
(12) Patent Application Publication
(10) Pub. No.: US 2026/0270052 A1
(43) Pub. Date: Sep. 10, 2026

(54) Global Quantum-Secured Financial Infrastructure with AI-Enhanced Credit Card Management, Multi-Dimensional Risk Control, Decentralized Compliance Mechanisms, and Human-Machine Interactive Communication

(71) Applicant: FURONG BEI, San Gabriel, CA (US)

(72) Inventor: FURONG BEI, San Gabriel, CA (US)

(21) Appl. No.: 19/072,075

(22) Filed: Mar. 6, 2025

(51) Int. Cl. H04L 9/08; G06Q 20/40

(52) U.S. Cl. CPC H04L 9/0852; G06Q 20/4016; H04L 9/0869

(57) ABSTRACT

A global financial infrastructure is disclosed which integrates quantum-secured systems, artificial intelligence (AI), and blockchain-based decentralized governance to create a new paradigm for credit management and digital economies. The system utilizes quantum key distribution (QKD) and quantum random number generation (QRNG) for fundamentally secure transactions and identity verification. An AI engine performs real-time credit risk assessment and calculates a Behavior Economic Index (BEI) to enable a new class of dynamic, behavior-based financial products. Governance is achieved through a decentralized autonomous organization (DAO) with token-based profit sharing and compliance mechanisms managed by smart contracts. The system is architected for infinite scalability and is intended for commercial deployment through the ATMS. com global platform by a corporate entity, ATMSpac, Inc., providing a comprehensive, vertically integrated model for a new global digital economy with a clear path to public markets.

### TECHNICAL FIELD

The present invention relates generally to financial technology (FinTech), specifically integrating quantum-secured systems, artificial intelligence (AI)-enhanced credit card management, multi-dimensional fraud detection, blockchain-based transparent auditability, decentralized regulatory compliance, cross-domain identity management, automated transaction monitoring, and interactive human-machine interactive communication.

### BACKGROUND OF THE INVENTION

Traditional credit card management systems face numerous vulnerabilities, including centralized data storage risks, fraud and identity theft threats, inefficient compliance verification, fragmented regulatory adherence, limited human-machine interactivity, and poor adaptability to global market changes. The advent of quantum computing further intensifies these security risks, requiring novel encryption methods and integrated, real-time risk management solutions that current infrastructures cannot provide. This invention provides a comprehensive technical solution to these longstanding problems.

### BRIEF SUMMARY OF THE INVENTION

The invention introduces a quantum-secured financial infrastructure designed specifically for credit card management, integrating AI-driven dynamic credit risk assessments, multi-dimensional fraud prevention, decentralized compliance mechanisms, blockchain-based granular auditing, quantum encryption, and advanced human-machine interactive communication. This system automates credit card issuance, limit adjustments, transaction monitoring, and risk mitigation through decentralized smart contracts, enhancing user data privacy, security, regulatory compliance, and user interaction on a global scale.

### BRIEF DESCRIPTION OF THE SEVERAL VIEWS OF THE DRAWING

FIG. 1—System Architecture Illustrates the five-layer system stack integrating quantum identity, AI modules, DAO governance, and decentralized access.

FIG. 2—Quantum-Secured Identity Authentication Workflow Shows the user enrollment, quantum key exchange, identity issuance, and secure storage.

FIG. 3—AI-Driven Risk & Credit Engine Workflow Displays real-time data ingestion, fraud anomaly detection, and dynamic interest rate adjustments.

FIG. 4—Fraud Prevention Mechanism Highlights a multi-layered architecture comparing behavioral, transaction, biometric, and device data in real-time.

FIG. 5—Dynamic Credit Risk Adjustment & Smart Contract Execution Illustrates how AI-modified risk scores feed into smart contracts for automatic credit issuance and rebalancing.

FIG. 6—Blockchain Audit Ledger Shows how every compliance action, identity approval, and financial transaction is hashed and permanently stored on-chain.

FIG. 7—Cross-Chain Gateway Displays interactions between Ethereum-compatible chains, stablecoins, and CBDC gateways within the BI ecosystem.

FIG. 8—Environmental Sustainability in Node Operation Shows the dynamic allocation of PoS validators based on energy efficiency using AI routing.

FIG. 9—Co-Ownership Token Mechanism Outlines token issuance based on reputation, staking, contribution and usage across multiple BI services.

FIG. 10—AI-Powered Human-Machine Financial Interface Displays natural language interfaces for personalized advisory, real-time notifications, and automated financial behavior.

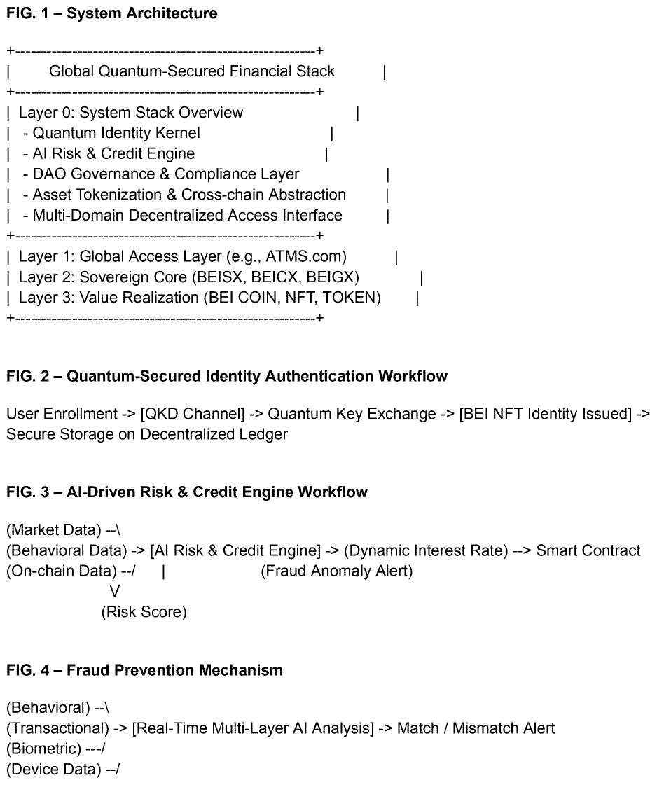

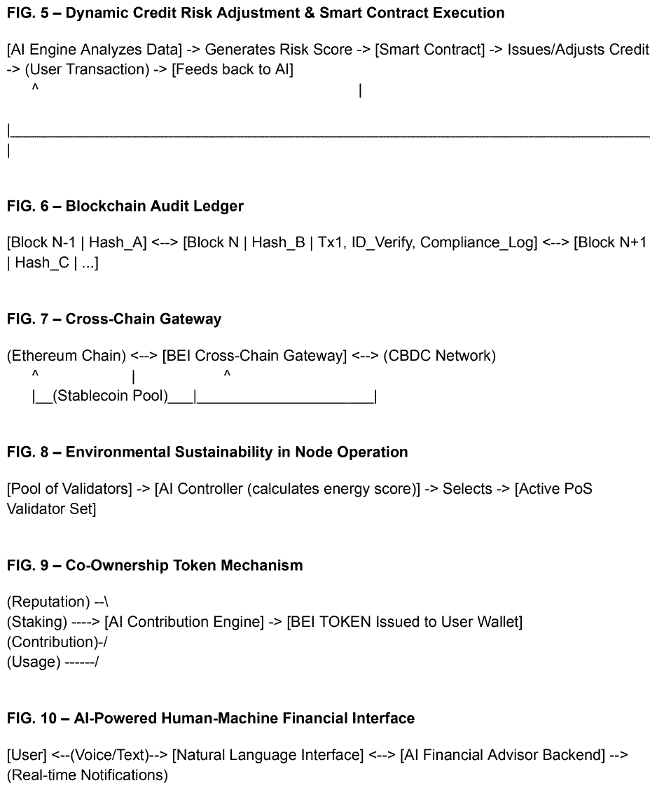

### DETAILED DESCRIPTION OF THE INVENTION

### Core Ecosystem Workflow and Value Creation Cycle

To illustrate the invention's practical application, a typical user journey and value cycle within the ecosystem is described as follows. This workflow demonstrates the seamless integration of identity, data, artificial intelligence, and tokenomics, forming a self-sustaining economic feedback loop.
1. Identity Genesis: The cycle begins with the establishment of a sovereign digital identity (DID). A user accesses the ecosystem, for example through BEI-DID.com, where a unique, quantum-secured digital identity is generated and anchored to the blockchain, creating a BI NFT that serves as the user's economic passport.
2. Behavioral Data Aggregation: With user consent, the system aggregates permissioned behavioral data from a user's on-chain and off-chain activities.
3. Value Quantification via the BEI Engine: This data is continuously processed by the core BEI Algorithm Engine. This engine, an embodiment of the AI system of claim 2, leverages machine learning to analyze the data and generate a dynamic, real-time Behavior Economic Index (BEI) score.
4. Credit Token (BCT) Issuance: A key innovation is the ecosystem's quasi-central banking portal, beicb.com. Based on a user's BEI score, this entity programmatically issues a native utility token, the BCT (BEI Credit Token), representing a quantifiable measure of the user's value and reputation.
5. Service Layer Activation: The issued BCT acts as a key to unlock a suite of financial services across specialized platforms, including beicredit.com (credit), beiescrow.com (escrow), and beisec.com (compliance).
6. Global Clearing and Exchange: Ultimately, all assets flow into the core global exchanges, BEISX.com and BEIGX.com, BEICX.com for final clearing, exchange, and circulation against global currencies.

### Exemplary Commercial Embodiments, Ecosystem Architecture, and Value Realization

The present invention is not merely a set of isolated technologies, but a foundational blueprint for a global, self-sustaining, and infinitely scalable digital economic ecosystem. It addresses critical technical problems in legacy financial systems, including centralized identity risks, static interest models, compliance fragmentation, and lack of asset composability. The system stack comprises a Quantum-secured Identity Kernel, an AI-driven Risk & Credit Optimization Layer, a DAO-based Governance and Compliance Layer, an Asset Tokenization & Cross-chain Abstraction Layer, and a Multi-domain Decentralized Access Interface. Each layer solves a discrete set of industry challenges while interoperating within a vertically integrated sovereign framework.

The ecosystem is architected in three primary layers:
Layer 1 (The Global Access & Service Network): Designed to be accessible to 8.3 billion global citizens through a network of up to 2,000 unique domains, including flagship portals like ATMS.com, 168Bank.com, BEIBANKING.com, and specialized gateways like beicredit.com and beieco.com.
Layer 2 (The Sovereign Core Engine): All transactions are processed through a trifurcated sovereign core, including BEISX.com (Security), BEICX.com (Clearing), and BEIGX.com (Governance).
Layer 3 (The Value Conversion & Realization Layer): Economic activity is converted into a unified set of digital assets, including a stable-value BEI COIN, a BEI TOKEN for governance and profit-sharing, and a BEI NFT for representing unique assets and identity.

This implementation leverages a hive-network architecture for scalability, AI-compliance engines for real-time KYC/AML adaptation, and decentralized audit trails for non-repudiable forensics.

### Commercial Acceleration & Capitalization Strategy

To further demonstrate the real-world feasibility and strategic execution of the invention, the applicant has initiated corporate structuring and early market operations under ATMSpac, Inc., a U.S.-based entity that will lead the commercialization, fundraising, and IPO strategy.

As part of its roadmap, ATMSpac is targeting an IPO, leveraging the invention's technological foundation (QKD-based identity, AI-enhanced credit, decentralized asset governance) to generate early revenue from fintech APIs, cross-border remittances, and BEI-driven credit markets. The invention's deployment within the ATMS.com→BEISX.com→BEICX.com→BEIGX.com ecosystem forms a complete capital and compliance infrastructure, increasing its potential for broad adoption and monetization.

What is claimed is:

1. A method for securing financial transactions within a digital infrastructure, the method comprising:
establishing a secure communication channel between a user device and a financial institution's server using quantum key distribution (QKD);
generating cryptographic keys for transaction authentication using a quantum random number generator (QRNG) to ensure non-deterministic randomness;
verifying a user's identity by processing quantum-encrypted identity credentials stored on a decentralized ledger; and
authorizing the financial transaction upon successful verification, thereby creating a quantum-secured audit trail on the decentralized ledger.

2. A financial management system, comprising:
a data-ingestion module configured to receive real-time transactional, behavioral, and market data;
an artificial intelligence (AI) engine operatively coupled to the data-ingestion module, the AI engine configured to:
dynamically assess a credit risk profile for a user by applying one or more deep learning algorithms to the received data,
detect potential fraud by identifying anomalies in the real-time data that deviate from an established behavioral baseline, and
automatically adjust a credit limit associated with the user based on the assessed credit risk profile and market data;
a user interface module configured to provide interactive, natural language financial advisory services generated by the AI engine.

3. A method for decentralized governance and collateral management in a financial system, the method comprising:
tokenizing a real-world asset into a digital asset token recorded on a blockchain;
assigning a co-ownership or governance token to a user based on an AI-calculated contribution metric, said governance token representing a right to participate in decision-making;
executing a financial transaction collateralized by the digital asset token via a multi-signature smart contract; and
distributing a share of transaction-generated profits to the user based on a quantity of the governance token held by the user, thereby enabling decentralized profit sharing.

4. The method of claim 1, further comprising employing decentralized data storage for the quantum-encrypted identity credentials.

5. The method of claim 1, wherein the quantum-secured audit trail is recorded on an environmentally sustainable blockchain utilizing a Proof-of-Stake (PoS) consensus mechanism.

6. The method of claim 1, further comprising a dual-layer quantum authorization protocol to enable transaction reversibility in the event of confirmed fraud.

7. The system of claim 2, wherein the AI engine is further configured to provide proactive customer service by predicting user financial needs.

8. The system of claim 2, wherein the interactive natural language financial advisory is provided via a conversational text or voice interface.

9. The system of claim 2, wherein the AI engine is further configured to dynamically deploy and update smart contracts to adapt to changing local regulatory requirements for KYC and AML.

10. The system of claim 2, wherein the AI engine is further configured to dynamically optimize a plurality of financial parameters for a user, said parameters including at least one of a credit limit or a lending interest rate, to maximize user benefit while mitigating institutional risk.

11. The system of claim 2, further comprising a multi-layered fraud prevention module that integrates data analysis across multiple financial domains.

12. The system of claim 2, wherein the AI engine further includes an automated market-making (AMM) module for optimizing liquidity.

13. The method of claim 3, wherein the real-world asset is one of real estate or intellectual property.

14. The method of claim 3, further comprising an AI-driven valuation module for dynamically monitoring the value of the tokenized asset.

15. The method of claim 3, further comprising automatically liquidating the digital asset token when its dynamically monitored value falls below a predefined collateral threshold.

16. The method of claim 3, wherein the decentralized governance is implemented via a multi-council organizational structure, and wherein high-level decisions require approval from a plurality of councils via multi-signature smart contracts.

17. The method of claim 3, wherein the financial system supports cross-chain interoperability implemented through a hive-network architecture of interconnected ledgers configured to provide horizontally scalable transaction throughput.

18. The method of claim 3, wherein the user's contribution metric is calculated based on their transactional activity, liquidity provision, and governance participation.

19. The method of claim 3, further comprising managing user identities securely across multiple blockchain domains.

20. The method of claim 3, wherein the blockchain utilizes low-energy consensus protocols dynamically managed by an AI to minimize environmental impact.
